(19) United States
(12) Patent Application Publication
(10) Pub. No.: US 2022/0129114 A1
(43) Pub. Date: Apr. 28, 2022

(54) TOUCH PANEL SYSTEM AND DISPLAY DEVICE

(71) Applicant: SHARP KABUSHIKI KAISHA, Sakai-City (JP)

(72) Inventors: SHINJI YAMAGISHI, Osaka (JP); TAKENORI MARUYAMA, Osaka (JP); KAZUTOSHI KIDA, Osaka (JP); TAKUMA YAMAMOTO, Osaka (JP); YASUHIRO SUGITA, Osaka (JP)

(21) Appl. No.: 17/477,477

(22) Filed: Sep. 16, 2021

(30) Foreign Application Priority Data
Oct. 28, 2020 (JP) 2020-180158

(51) Int. Cl. G06F 3/044

(52) U.S. Cl. CPC G06F 3/0443; G06F 2203/04105; G06F 3/0448

(57) ABSTRACT

A touch panel system includes a touch panel including a drive electrode, a position detection electrode, and a pressure detection electrode, and a controller configured to impart a drive signal to the drive electrode and acquire signal values from each of the position detection electrode and the pressure detection electrode. The controller detects a position of an indicator on the basis of the signal values obtained from the position detection electrode and calculates a magnitude of pressure applied by the indicator on the basis of signal values in a pressure detection range corresponding to the detected position of the indicator among the signal values obtained from the pressure detection electrode.

### CROSS-REFERENCE TO RELATED APPLICATIONS

This application claims the benefit of priority to Japanese Patent Application Number 2020-180158 filed on Oct. 28, 2020. The entire contents of the above-identified application are hereby incorporated by reference.

### BACKGROUND

### Technical Field

The present disclosure relates to a touch panel system that detects the position of an indicator, such as a finger or a touch pen, and the magnitude of pressure applied by the indicator, and to a display device including the touch panel system.

In recent years, mutual-capacitive touch panels have been in wide use. A mutual-capacitive touch panel includes a drive electrode to which a drive signal is input and a detection electrode. In this touch panel, an indicator is capacitively coupled to each of the drive electrode and the detection electrode, and thus electrostatic capacitance between both the electrodes decreases, and a signal of the detection electrode changes. The position of the indicator is detected on the basis of a change in the signal of the detection electrode.

For example, JP 2014-179035 A proposes a touch panel system that reduces the influence of noise to detect the position of an indicator with high accuracy by integrating (cumulatively adding) a difference value between signals obtained from two types of detection electrodes, namely, a main sensor and a sub-sensor.

### SUMMARY

In a touch panel having a configuration capable of detecting the position of an indicator and the magnitude of pressure applied by the indicator, electrodes for detecting these may be provided separately. Even when a controller of the related art as disclosed in JP 2014-179035 A is combined with such a touch panel, the position and pressure applied by the indicator cannot be detected simultaneously.

Thus, the present disclosure provides a touch panel system capable of simultaneously detecting the position of an indicator and the magnitude of pressure applied by the indicator, and a display device including the touch panel system.

In order to solve the above-described problems, a touch panel system according to an embodiment of the present disclosure includes a touch panel including a drive electrode, a position detection electrode, and a pressure detection electrode, and a controller configured to impart a drive signal to the drive electrode and acquire signal values from each of the position detection electrode and the pressure detection electrode, and the controller detects a position of an indicator on the basis of the signal values obtained from the position detection electrode and calculates a magnitude of pressure applied by the indicator on the basis of signal values in a pressure detection range corresponding to the detected position of the indicator among the signal values obtained from the pressure detection electrode.

In the touch panel system having the configuration described above, the controller detects the position of the indicator and calculates a pressure value on the basis of the signal values in the pressure detection range corresponding to the position. Thus, the touch panel system can simultaneously detect the position of the indicator and the magnitude of pressure applied by the indicator.

### BRIEF DESCRIPTION OF DRAWINGS

The disclosure will be described with reference to the accompanying drawings, wherein like numbers reference like elements.

FIG. 1 is a block diagram illustrating a configuration of a touch panel system S according to a first embodiment.

FIG. 2 is a plan view illustrating a configuration of an electrode included in a touch panel 1.

FIG. 3 is a plan view illustrating a configuration of an electrode included in the touch panel 1.

FIG. 4 is a cross-sectional view illustrating a cross section taken along a line A-A in FIGS. 2 and 3.

FIG. 5 is a cross-sectional view illustrating a configuration of a display device P including the touch panel system S according to the first embodiment.

FIG. 6 is a flowchart illustrating a method of detecting the position of an indicator and the magnitude of pressure applied by the indicator, by a controller 2 included in the touch panel system S according to the first embodiment.

FIG. 7 is a schematic diagram illustrating a configuration example of input data ID which is processed by the controller 2.

FIG. 8 is a schematic diagram illustrating a method of calculating a specific position of an indicator by the controller 2.

FIG. 9 is a flowchart illustrating a method of detecting the position of an indicator and the magnitude of pressure applied by the indicator, by a controller 2 included in a touch panel system S according to a second embodiment.

FIG. 10 is a flowchart illustrating a method of detecting the position of an indicator and the magnitude of pressure applied by the indicator, by a controller 2 included in a touch panel system S according to a third embodiment.

FIG. 11 is a flowchart illustrating a method of detecting the position of an indicator and the magnitude of pressure applied by the indicator, by a controller 2 included in a touch panel system S according to a fourth embodiment.

### DESCRIPTION OF EMBODIMENTS

Hereinafter, embodiments of the present disclosure will be described in detail with reference to the drawings. In the drawings, the same or corresponding portions are denoted by the same reference numerals and signs, and the description thereof will not be repeated. Note that, for ease of description, in the drawings referred to below, configurations may be simplified or schematically illustrated, and some components may be omitted. Further, dimensional ratios between components illustrated in the drawings are not necessarily indicative of actual dimensional ratios. Further, in the drawings referred to below, various electrodes are displayed with hatching in order to facilitate the identification of the various electrodes.

### First Embodiment

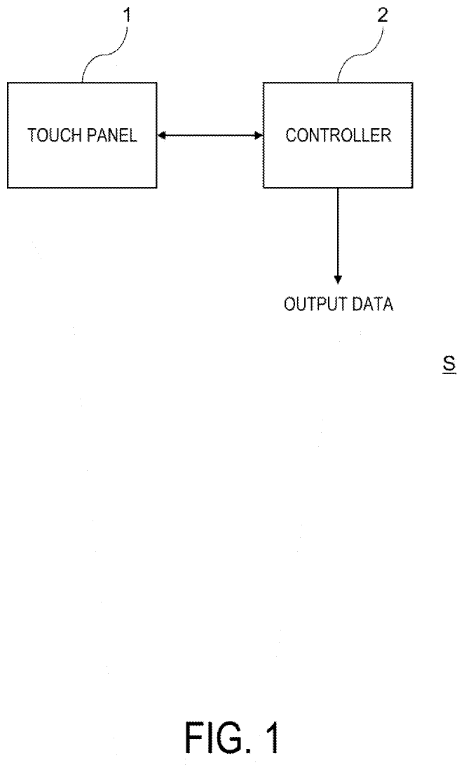

First, a configuration of a touch panel system S will be described with reference to the drawings. FIG. 1 is a block diagram illustrating a configuration of a touch panel system S according to a first embodiment. As illustrated in FIG. 1, the touch panel system S includes a touch panel 1 and a controller 2.

The touch panel 1 includes a drive electrode, a position detection electrode, and a pressure detection electrode, as will be described below. The controller 2 imparts a drive signal to the drive electrode to obtain a signal from each of the position detection electrode and the pressure detection electrode and generate output data including the position of an indicator and the magnitude of pressure applied by the indicator. For example, the output data is used for the control of an image displayed on a display device, and the like in a control unit included in the display device including the touch panel system S.

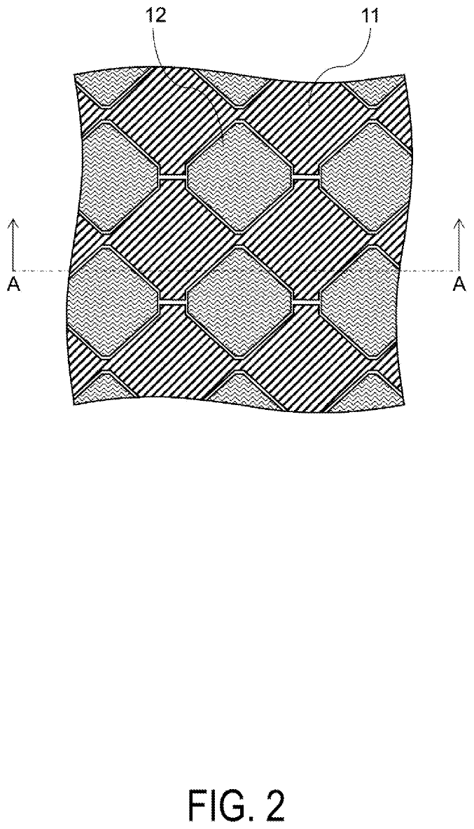

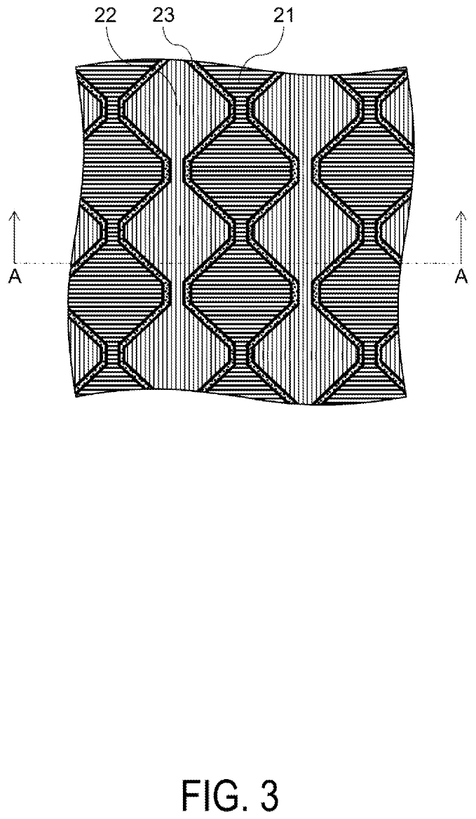

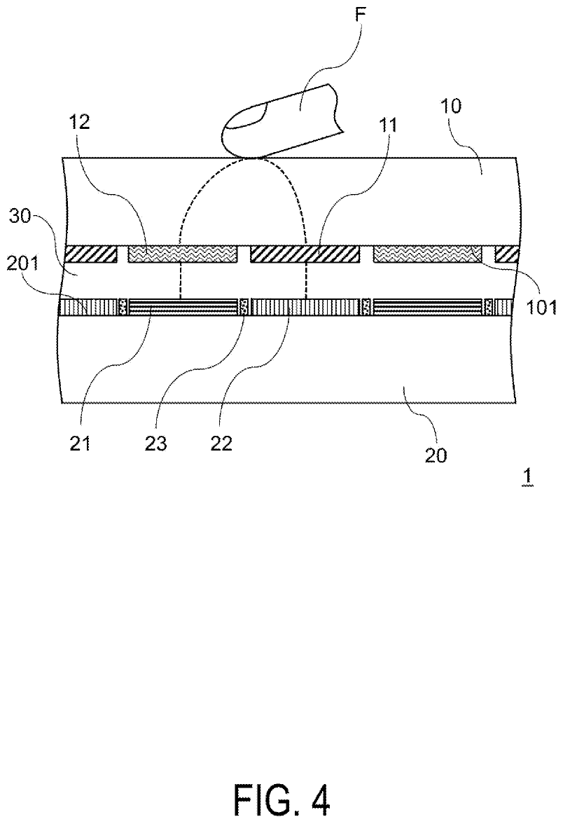

Next, a configuration of the touch panel 1 will be described with reference to the drawings. FIGS. 2 to 4 are diagrams illustrating a schematic configuration of the touch panel 1 according to the first embodiment. FIGS. 2 and 3 are plan views illustrating a configuration of electrodes included in the touch panel 1 according to the first embodiment. FIG. 4 is a cross-sectional view illustrating a cross section taken along a line A-A in FIGS. 2 and 3. Note that, for ease of illustration, the electrodes included in the touch panel 1 are illustrated separately in FIGS. 2 and 3, but as illustrated in FIG. 4, the electrodes illustrated in FIGS. 2 and 3 are layered.

As illustrated in FIG. 4, the touch panel 1 includes a first substrate 10, a drive electrode 11, a floating island electrode 12, a second substrate 20, a position detection electrode 21, a pressure detection electrode 22, a shield electrode 23, and a dielectric layer 30. For example, the first substrate 10 and the second substrate 20 may be each formed of a transparent material such as a glass polyethylene terephthalate (PET) film. In addition, the drive electrode 11, the floating island electrode 12, the position detection electrode 21, the pressure detection electrode 22, and the shield electrode 23 are formed of a conductive transparent material such as Indium Tin Oxide (ITO). In addition, the dielectric layer 30 is formed of an elastic transparent material such as a polymeric material, an Optical Clear Adhesive (OCA), or an Optical Clear Resin (OCR).

The first substrate 10 and the second substrate 20 are disposed such that a first surface 101 of the first substrate 10 and a second surface 201 of the second substrate 20 face each other. The drive electrode 11 is an electrode to which a drive signal is imparted and is formed on the first surface 101. The floating island electrode 12 is in a floating state and is formed on the first surface 101.

The position detection electrode 21 is an electrode for detecting the position of an indicator and is formed on the second surface 201. The pressure detection electrode 22 is an electrode for detecting the magnitude of pressure applied by the indicator and is formed on the second surface 201. The shield electrode 23 is provided with a potential equal to a ground potential or a potential provided to the position detection electrode 21 or the pressure detection electrode 22 or is in a floating state, and is formed on the second surface 201.

As illustrated in FIG. 2, the drive electrode 11 has a shape (diamond pattern) in which a plurality of rhombus-shaped electrodes are connected to each other in a diagonal direction thereof. In addition, the floating island electrode 12 is constituted by a plurality of rhombus-shaped electrodes D2 that are not connected to each other.

As illustrated in FIG. 3, the position detection electrode 21 has a diamond pattern in which a plurality of rhombus-shaped electrodes are connected to each other, similar to the drive electrode 11. Further, the pressure detection electrode 22 also has a diamond pattern in which a plurality of rhombus-shaped electrodes are connected to each other. A connecting direction in which the rhombus-shaped electrodes of the position detection electrode 21 are connected and a connecting direction in which the rhombus-shaped electrodes of the pressure detection electrode 22 are connected are parallel to each other, and the position detection electrode 21 and the pressure detection electrode 22 are alternately disposed with respect to a direction perpendicular to the connecting directions. The connecting direction of the rhombus-shaped electrodes in each of the position detection electrode 21 and the pressure detection electrode 22 is perpendicular to the connecting direction of the rhombus-shaped electrodes in the drive electrode 11.

In addition, as illustrated in FIGS. 3 and 4, the shield electrode 23 is disposed between the position detection electrode 21 and the pressure detection electrode 22. For example, the shield electrode 23 may be disposed between the position detection electrode 21 and the pressure detection electrode 22 to separate these electrodes from each other.

When the second substrate 20 is viewed from the first substrate 10 in a plan view (hereinafter, simply referred to as a “plan view”), the drive electrode 11 covers at least a portion of the pressure detection electrode 22. Note that in the touch panel 1 illustrated in FIGS. 2 to 4, one rhombus-shaped electrode constituting the drive electrode 11 includes one rhombus-shaped electrode constituting the pressure detection electrode 22 in a plan view. Similarly, one rhombus-shaped electrode constituting the floating island electrode 12 includes one rhombus-shaped electrode constituting the position detection electrode 21 in a plan view.

Next, operations of the touch panel 1 will be described with reference to the drawings. In FIG. 4, capacitive coupling occurring between an indicator F and various electrodes and electrical lines of force corresponding to capacitive coupling occurring between the various electrodes are indicated by dashed lines. As illustrated in FIG. 4, when the indicator F comes into contact with the surface of the first substrate 10 on a side opposite to the first surface 101, the drive electrode 11 and the floating island electrode 12 are capacitively coupled to each other. At this time, the floating island electrode 12 and the position detection electrode 21 are capacitively coupled to each other, and thus the drive electrode 11 and the position detection electrode 21 are capacitively coupled to each other via the floating island electrode 12. Thereby, electrostatic capacitance between the drive electrode 11 and the position detection electrode 21 decreases via the indicator F, and a signal detected at the position detection electrode 21 changes, whereby the position of the indicator F is detected.

Additionally, as illustrated in FIG. 4, the drive electrode 11 and the pressure detection electrode 22 are capacitively coupled to each other. Here, when the first substrate 10 is pressed by the indicator F, a distance between the drive electrode 11 and the pressure detection electrode 22 decreases because the dielectric layer 30 is a material having elasticity. Thereby, electrostatic capacitance between both the electrodes 11 and 22 increases, and a signal detected at the pressure detection electrode 22 changes, whereby the magnitude of pressure is detected.

When the first substrate 10 is pressed by the indicator F, the distance between the drive electrode 11 and the position detection electrode 21 decreases. However, since the drive electrode 11 is closer to the shield electrode 23 than to the position detection electrode 21, the drive electrode 11 is likely to be capacitively coupled to the shield electrode 23. Thus, electrostatic capacitance between the drive electrode 11 and the position detection electrode 21 is less likely to increase, and the decrease in electrostatic capacitance between the drive electrode 11 and the position detection electrode 21 due to the indicator F is less likely to be canceled out.

In addition, since the indicator F is closer to the shield electrode 23 than to the pressure detection electrode 22 on a path from the indicator F to the pressure detection electrode 22, the indicator F is likely to be capacitively coupled to the shield electrode 23. Thus, the indicator F is inhibited from being capacitively coupled to each of the drive electrode 11 and the pressure detection electrode 22, and this inhibits electrostatic capacitance between both the electrodes from fluctuating.

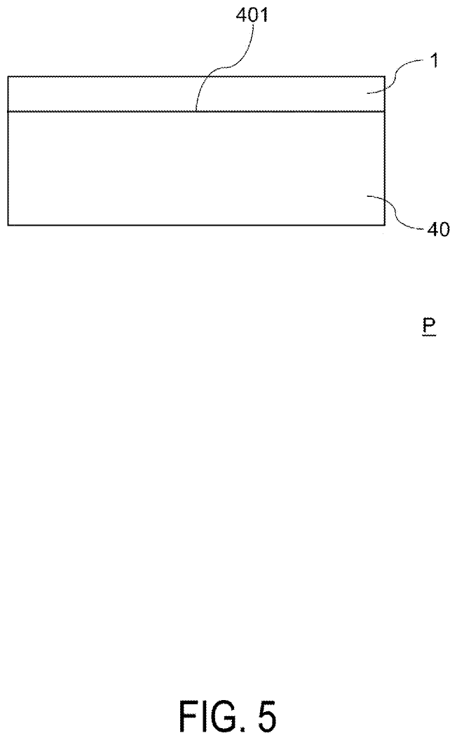

The touch panel system S is included in, for example, a display device. FIG. 5 is a cross-sectional view illustrating a configuration of a display device P including the touch panel system S according to the first embodiment. As illustrated in FIG. 5, the display device P includes the touch panel 1 and a display unit 40 that displays an image on a display surface 401. The display unit 40 may be configured by, for example, a liquid crystal display, an organic Electro Luminescence (EL) display, or the like. The touch panel 1 is disposed on the display surface 401 of the display unit 40 such that the second substrate 20 is adjacent to the display unit 40 side.

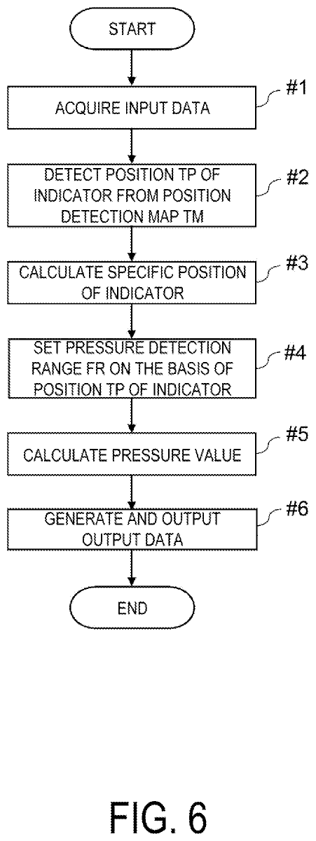

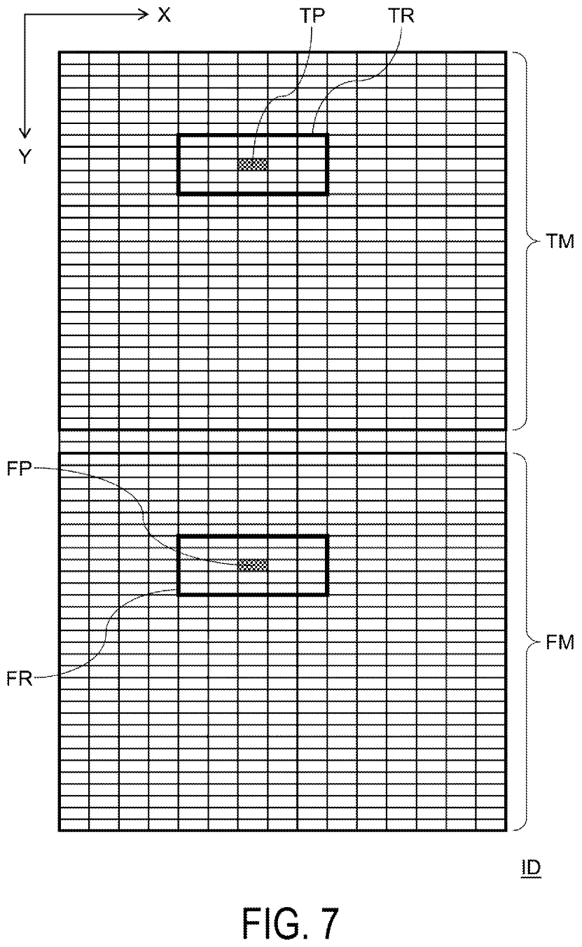

Next, a method of detecting the position of the indicator F and the magnitude of pressure applied by the indicator F, by the controller 2 will be described with reference to the drawings. FIG. 6 is a flowchart illustrating a method of detecting the position of the indicator F and the magnitude of pressure applied by the indicator F by the controller 2 included in the touch panel system S according to the first embodiment. FIG. 7 is a schematic diagram illustrating a configuration example of input data ID to be processed by the controller 2.

As illustrated in FIG. 6, the controller 2 first acquires the input data ID (step #1). At this time, the controller 2 imparts a drive signal to the drive electrode 11 and acquires signals from the position detection electrode 21 and the pressure detection electrode 22 to acquire input data ID.

Here, the input data ID will be described with reference to the drawings. The input data ID illustrated in FIG. 7 is data obtained in a case where the number of drive electrodes 11 is 15 and the number of position detection electrodes 21 and the number of pressure detection electrodes 22 are both 32. The input data ID is data having elements represented by two-dimensional coordinates of (X, Y). An X direction is a direction in which the drive electrodes 11 are aligned, and a Y direction is a direction in which the position detection electrodes 21 and the pressure detection electrodes 22 are aligned. Note that, in the following, a direction in which the value of Y increases will be represented as a downward direction, and a direction in which the value of Y decreases will be represented as an upward direction.

The input data ID is data that is a combination of signal values obtained from the position detection electrodes 21 and the pressure detection electrodes 22 in different regions of a single two-dimensional coordinate system. The input data ID illustrated in FIG. 7 illustrates a position detection map TM in which signal values obtained from the position detection electrodes 21 and a position detection map TM in which signal values obtained from the pressure detection electrodes 22 are disposed in different regions so that the position detection map TM is on the upper side and the pressure detection map FM is on the lower side with two rows of dummies in the center portion in the Y direction. As illustrated in FIGS. 3 and 4, the position detection electrodes 21 and the pressure detection electrodes 22 are alternately arranged, but in the input data ID, the signal values obtained from the respective electrodes are separated. In the input data ID illustrated in FIG. 7, a signal value corresponding to electrostatic capacitance formed by an X-th drive electrode 11 and a Y-th position detection electrode 21 with a certain corner on the touch panel 1 as an origin is an element of (X, Y). On the other hand, the signal value corresponding to the electrostatic capacitance formed by the X-th drive electrode 11 and a Y-th pressure detection electrode 22 is an element of (X, Y+34).

Hereinafter, description will be given of an example in a case where a signal value of an element equivalent to the vicinity of the center of a contact portion of the indicator F in the position detection map TM increases to a positive value, and a signal value of an element equivalent to the vicinity of the center of a contact portion of the indicator F in the pressure detection map FM increases to a positive value in a case where the surface of the touch panel 1 is pressed by the indicator F in the input data ID.

Next, the controller 2 detects a position TP of the indicator F from the position detection map TM of the input data ID (step #2). For example, the controller 2 detects an element of which the signal value is equal to or greater than a predetermined threshold and is a maximum in the position detection map TM among the elements in the position detection map TM, as the position TP of the indicator F. Note that in a case where there is no element of which the signal value is equal to or greater than the threshold value in the position detection map TM, the controller 2 may determine that the indicator F that is in contact with the touch panel 1 is not present, and output output data indicating the absence of the indicator F.

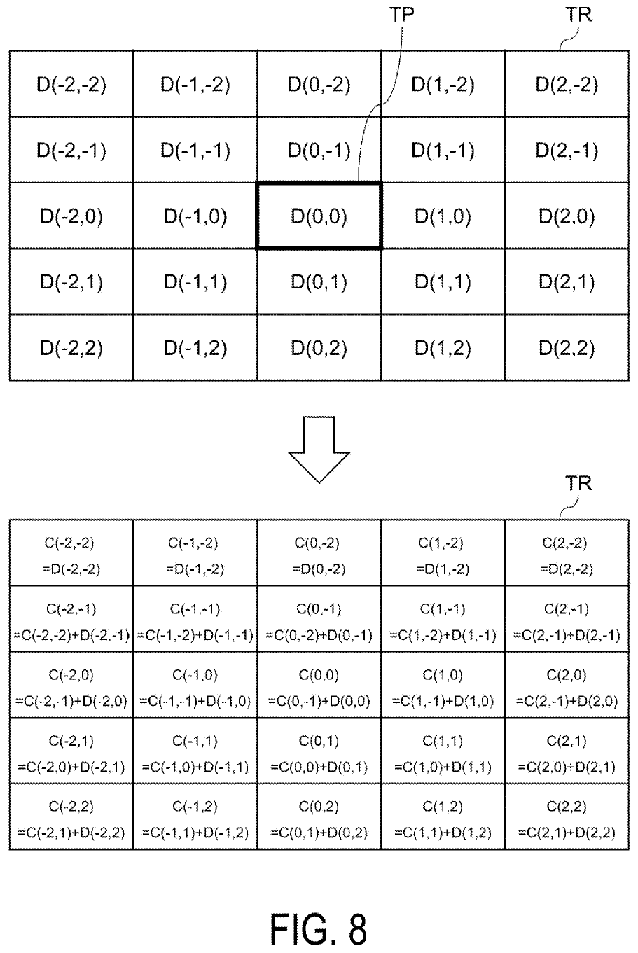

Next, the controller 2 calculates a specific position of the indicator F (step #3). A method of calculating the specific position by the controller 2 will be described with reference to FIG. 8. FIG. 8 is a schematic diagram illustrating a method of calculating a specific position of an indicator by the controller 2. Note that, in FIG. 8, the position TP of the indicator F is indicated as (0, 0).

As illustrated in FIGS. 7 and 8, the controller 2 sets a position detection range TR having a size of A×B to include the position TP of the indicator F detected in step #2. FIGS. 7 and 8 illustrate a case where a 5×5 region is set as the position detection range TR with the position TP of the indicator F as a center. Note that, in a case where the position detection range TR having a size of 5×5 is set with the position TP of the indicator F as a center and a portion of the position detection range TR protrudes from the position detection map TM, the position detection range TR may be set to be smaller than a size of 5×5 by deleting the protruding portion, or may be set to have a size of 5×5 but fit within the position detection map TM by shifting the position TP of the indicator F from the center.

The controller 2 calculates a signal value C(X, Y) by cumulatively adding signal values D(X, Y) in the position detection range TR in the Y direction. Specifically, the controller 2 calculates the signal value C(X, Y) from C(X, Y=C(X, Y−1)+D(X, Y). However, when the signal value C(X, Y is calculated, the controller 2 sets C(X, Y)=D(X, Y) for elements at an upper end in the position detection range TR for which C(X, Y−1) cannot be calculated.

For the calculated signal value C(X, Y), the controller 2 calculates the position of the center of gravity on the basis of the magnitude of the signal value and coordinates (X, Y), and sets the position of the center of gravity as a specific position of the indicator F. When the specific position of the indicator F is calculated in this way, the position of the indicator F which is present between the coordinates (X, Y) can be detected, and thus a resolution for detecting the position of the indicator F can be improved.

Next, the controller 2 sets a pressure detection range FR in the pressure detection map FM of the input data ID (step #4). As illustrated in FIG. 7, the controller 2 sets the pressure detection range FR having a size C×D to include the position TP of the indicator F detected in step #2. FIG. 7 illustrates a case where a region of 5×5 is set as the pressure detection range FR centering on the position FP in the pressure detection map FM corresponding to the position TP of the indicator F. In the case of the example illustrated in FIG. 7, an X coordinate of the position FP is the same as that of the position TP, and a Y coordinate of the position FP is a value obtained by adding 34 to the Y coordinate of the position TP. Note that, in a case where the pressure detection range FR having a size of 5×5 is set with the position FP as a center and a portion of the pressure detection range FR protrudes from the pressure detection map FM, the pressure detection range FR may be set to be smaller than a size of 5×5 by deleting the protruding portion, or may be set to have a size of 5×5 but fit within the pressure detection map FM without being centered on the position FP.

Next, the controller 2 calculates a pressure value which is the magnitude of pressure applied by the indicator F, on the basis of signal values in the pressure detection range FR (step #5). For example, the controller 2 calculates the pressure value by adding up absolute values of the signal values in the pressure detection range FR. Note that, in a method of calculating a pressure value including a method of setting the pressure detection range FR, it is preferable to set a pressure value to be a value proportional to a pressing force, for example, when the indicator F, which is a fixed contact area, is pressed against the touch panel 1 while changing the pressing force.

Finally, the controller 2 generates and outputs output data including the specific position and the pressure value of the indicator F (step #6).

As described above, in the touch panel system S, the controller 2 detects the position TP of the indicator F, and calculates a pressure value on the basis of the signal value of the pressure detection range FR corresponding to the position TP (the position FP). Thus, the touch panel system S can simultaneously detect the position of the indicator F and the magnitude of pressure applied by the indicator F.

Further, in the touch panel system S, the input data ID is composed of a combination of signal values obtained from each of the position detection electrode 21 and the pressure detection electrode 22 in different regions of a single two-dimensional coordinate system. Thus, it is possible to obtain the controller 2 that is applicable to the touch panel system S by simply changing the design of the controller that detects only the position of the indicator F of the related art.

### Second Embodiment

Next, a second embodiment will be described. The second embodiment differs from the first embodiment in terms of the method of calculating a pressure value by the controller 2. Thus, a method of calculating a pressure value in the second embodiment will be described below.

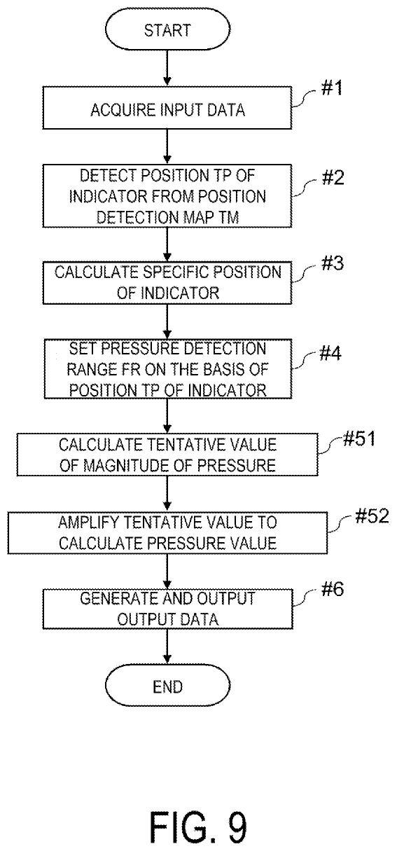

FIG. 9 is a flowchart illustrating a method of detecting the position of an indicator and the magnitude of pressure applied by the indicator, by a controller 2 included in a touch panel system S according to the second embodiment. As illustrated in FIG. 9, the controller 2 calculates a tentative value of the magnitude of pressure applied by an indicator F (step #51). At this time, the controller 2 calculates the tentative value by a calculation method similar to that for a pressure value in the first embodiment.

Next, the controller 2 amplifies the tentative value to calculate a pressure value (step #52). A method of amplifying the tentative value is arbitrary. For example, the controller 2 may multiply the tentative value by an amplification factor and then add or subtract an offset value to or from the value to calculate a pressure value.

As described above, in the touch panel system S, the controller 2 amplifies a tentative value to calculate a pressure value. Thus, the touch panel system S can accurately calculate the pressure value corresponding to the magnitude of pressure applied by the indicator F.

### Third Embodiment

Next, a third embodiment will be described. Also, in the third embodiment, a pressure value is calculated by amplifying a tentative value in the same manner as in the second embodiment, but the amplification method thereof is unique. Thus, the method of amplifying a tentative value according to the third embodiment will be described below.

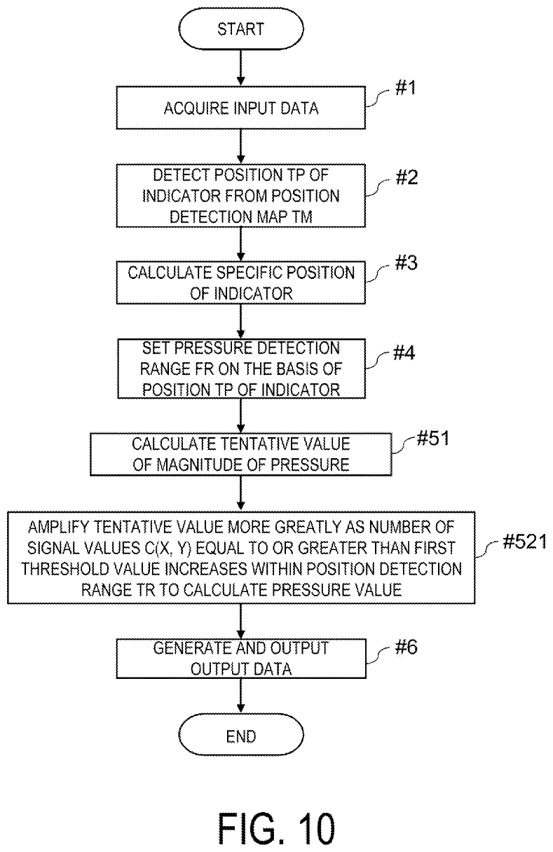

FIG. 10 is a flowchart illustrating a method of detecting the position of an indicator and the magnitude of pressure applied by the indicator, by a controller 2 included in a touch panel system S according to the third embodiment. As illustrated in FIG. 10, the controller 2 calculates a pressure value that is amplified more greatly as the number of signal values C(X, Y) equal to or greater than a first threshold value increases among signal values C(X, Y) in a position detection range TR for calculating a specific position of an indicator F illustrated in FIG. 8 (step #521). For example, the controller 2 increases an amplification factor to be multiplied by a tentative value as the number of signal values C(X, Y) equal to or greater than the first threshold value increases. Note that the amplification factor may increase continuously in response to an increase in the number of signal values C(X, Y) equal to or greater than the first threshold value, or may increase in a stepwise manner. In addition, the controller 2 may multiply a tentative value by an amplification factor and then add or subtract an offset value corresponding to the amplification factor to or from the value to calculate a pressure value.

As a contact range of the indicator F increases, a force of pressure applied by the indicator becomes dispersed over a larger range, which may result in a case where a pressure value to be calculated becomes smaller. In the touch panel system S according to the third embodiment, the controller 2 amplifies a tentative value to calculate a pressure value as described above, thereby preventing the pressure value from decreasing in a case where a contact range of the indicator F increases.

As described above, in the touch panel system S, the controller 2 amplifies a tentative value more greatly as the number of signal values C(X, Y) equal to or greater than the first threshold value increases. Thus, even when a contact range of the indicator F increases, the touch panel system S can calculate a pressure value with high accuracy.

### Fourth Embodiment

Next, a fourth embodiment will be described. Also, in the fourth embodiment a pressure value is calculated by amplifying a tentative value in the same manner as in the second and third embodiments, but the fourth embodiment differs from the third embodiment in terms of the amplification method. Thus, a method of amplifying a tentative value according to the fourth embodiment will be described below.

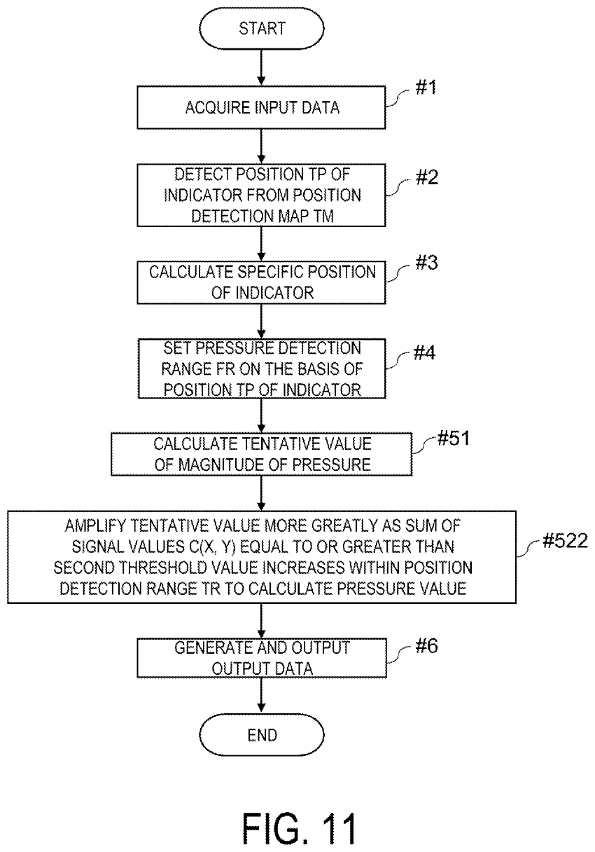

FIG. 11 is a flowchart illustrating a method of detecting the position of an indicator and the magnitude of pressure applied by the indicator, by a controller 2 included in a touch panel system S according to the fourth embodiment. As illustrated in FIG. 11, the controller 2 calculates a pressure value that is amplified more greatly as the sum of signal values C(X, Y) equal to or greater than a second threshold value increases among signal values C(X, Y) in a position detection range TR for calculating a specific position of an indicator F illustrated in FIG. 8 (step #522). For example, the controller 2 increases an amplification factor to be multiplied by a tentative value as the sum of signal values C(X, Y) equal to or greater than the second threshold value. Note that the amplification factor may increase continuously in response to an increase in the sum of signal values C(X, Y) equal to or greater than the second threshold value, or may increase in a stepwise manner. In addition, the controller 2 may multiply a tentative value by an amplification factor and then add or subtract an offset value corresponding to the amplification factor to or from the value to calculate a pressure value. In addition, the second threshold value may be 0.

Similar to the second embodiment, also in the touch panel system S according to the third embodiment, the controller 2 calculates a pressure value by amplifying a tentative value as described above, thereby preventing the pressure value from decreasing in a case where a contact range of the indicator F increases.

As described above, in the touch panel system S, the controller 2 amplifies a tentative value more greatly as the number of signal values C(X, Y) equal to or greater than the first threshold value increases. Thus, even when a contact range of the indicator F increases, the touch panel system S can calculate a pressure value with high accuracy.

Further, in the third embodiment, the magnitude of amplification is determined in accordance with the sum of signal values C(X, Y), and thus it is possible to prevent the magnitude of amplification from varying due to a slight difference in one signal value C(X, Y), unlike in a case where the magnitude of amplification is determined in accordance with the number of signal values C(X, Y). Thus, a pressure value can be calculated with higher accuracy.

Modifications and the Like

The above-described embodiments are merely examples for carrying out the present disclosure. Accordingly, the present disclosure is not limited to the embodiments described above and can be implemented by modifying the embodiments described above as appropriate without departing from the scope of the present disclosure.

For example, in the touch panel systems S in the first to third embodiments described above, a case where the controller 2 detects the position TP of the indicator F in step #2 and then calculates a specific position of the indicator in step #3 has been exemplified. However, the controller 2 may set coordinates of the position TP of the indicator F detected in step #2 as a specific position of the indicator F as is without performing step #3.

Further, in the touch panel systems S in the first to third embodiments described above, a case where the controller 2 sets the pressure detection range FR on the basis of the position TP of the indicator F detected in step #2 has been exemplified. However, the controller 2 may set the pressure detection range FR on the basis of the specific position of the indicator F calculated in step #3.

Further, in the touch panel systems S in the third and fourth embodiments described above, a case where the controller 2 amplifies a tentative value using an amplification method based on the signal values C(X, Y) has been exemplified, but a tentative value may be amplified by an amplification method based on signal values D(X, Y) before conversion to the signal values C(X, Y) illustrated in FIG. 8. Further, in the touch panel systems S, the controller 2 may determine the width of a contact range of the indicator F on the basis of indexes other than the number of signal values and the sum of the signal values.

Further, in the touch panel systems S in the first to third embodiments described above, the floating island electrode 12 and the shield electrode 23 need not be provided. In addition, each of the drive electrode 11, the floating island electrode 12, the position detection electrode 21, and the pressure detection electrode 22 may be formed in a pattern other than a diamond pattern. Additionally, some or all of the position detection electrode 21, the pressure detection electrode 22, and the shield electrode 23 may be formed of a mesh metal (thin metal wires having a mesh shape).

In addition, the touch panel system and the display device described above can be described as follows.

A touch panel system includes a touch panel including a drive electrode, a position detection electrode, and a pressure detection electrode, and a controller configured to impart a drive signal to the drive electrode and acquire signal values from each of the position detection electrode and the pressure detection electrode, and the controller detects a position of an indicator on the basis of the signal values obtained from the position detection electrode and calculates a magnitude of pressure applied by the indicator on the basis of signal values in a pressure detection range corresponding to the detected position of the indicator among the signal values obtained from the pressure detection electrode (first configuration). According to this configuration, the controller detects the position of the indicator and calculates a pressure value on the basis of the signal values in the pressure detection range corresponding to the position. Accordingly, the touch panel system can simultaneously detect the position of the indicator and the magnitude of pressure applied by the indicator.

In the first configuration, the controller may calculate the position of the indicator and the magnitude of pressure applied by the indicator on the basis of input data that is a combination of the signal values obtained from each of the position detection electrode and the pressure detection electrode in different regions of a single two-dimensional coordinate system (second configuration). Furthermore, in the second configuration, the controller may detect the position of the indicator from a position detection map constituted by the signal values obtained from the position detection electrode, and may set the pressure detection range which is in a pressure detection map constituted by the signal values obtained from the pressure detection electrode and includes a position corresponding to the position of the indicator (third configuration). According to this configuration, it is possible to obtain a controller 2 that is applicable to a touch panel system by simply changing the design of a controller that detects only the position of an indicator of the related art.

In any one of the first to third configurations, the controller may amplify a tentative value on the basis of the signal values in the pressure detection range to calculate the magnitude of pressure applied by the indicator (fourth configuration). According to this configuration, a pressure value corresponding to the magnitude of pressure applied by the indicator can be calculated with high accuracy.

In the fourth configuration, the controller may calculate the magnitude of pressure of the indicator by amplifying the tentative value more greatly as a contact range of the indicator becomes wider (fifth configuration). According to this configuration, it is possible to prevent a pressure value from decreasing in a case where the contact range of the indicator increases.

In the fifth configuration, the controller may calculate the magnitude of pressure applied by the indicator by greatly amplifying the tentative value as the number of signal values indicating a contact of the indicator increases within a position detection range including the detected position of the indicator (sixth configuration). According to this configuration, even when the contact range of the indicator has become larger, the magnitude of pressure applied by the indicator can be calculated with high accuracy.

Alternatively, in the fifth configuration, the controller may amplify the tentative value more greatly as the sum of the signal values indicating a contact of the indicator becomes larger within the position detection range including the detected position of the indicator (seventh configuration). According to this configuration, it is possible to prevent the magnitude of amplification from varying due to a slight difference in one signal value, and thus the magnitude of pressure applied by the indicator can be accurately calculated.

Another embodiment of the present disclosure is a display device that includes the touch panel system according to any one of the first to seventh configurations and a display unit configured to display an image, the display device being configured such that the touch panel is disposed on a display surface on which the display unit displays an image (eighth configuration).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A touch panel system comprising:
a touch panel including a drive electrode, a position detection electrode, and a pressure detection electrode; and
a controller configured to impart a drive signal to the drive electrode and acquire signal values from each of the position detection electrode and the pressure detection electrode,
wherein the controller detects a position of an indicator on the basis of the signal values obtained from the position detection electrode and calculates a magnitude of pressure applied by the indicator on the basis of signal values in a pressure detection range corresponding to the detected position of the indicator among the signal values obtained from the pressure detection electrode.

2. The touch panel system according to claim 1,
wherein the controller calculates the position of the indicator and the magnitude of pressure applied by the indicator on the basis of input data, the input data being a combination of the signal values obtained from each of the position detection electrode and the pressure detection electrode in different regions of a single two-dimensional coordinate system.

3. The touch panel system according to claim 2,
wherein the controller detects the position of the indicator from a position detection map constituted by the signal values obtained from the position detection electrode, and sets the pressure detection range which is in a pressure detection map constituted by the signal values obtained from the pressure detection electrode and which includes a position corresponding to the position of the indicator.

4. The touch panel system according to claim 1,
wherein the controller amplifies a tentative value based on the signal values in the pressure detection range to calculate the magnitude of pressure applied by the indicator.

5. The touch panel system according to claim 4,
wherein the controller calculates the magnitude of pressure applied by the indicator by amplifying the tentative value more greatly as a contact range of the indicator becomes wider.

6. The touch panel system according to claim 5,
wherein the controller calculates the magnitude of pressure applied by the indicator by more greatly amplifying the tentative value as the number of signal values indicating a contact of the indicator increases within a position detection range including the detected position of the indicator.

7. The touch panel system according to claim 5,
wherein the controller amplifies the tentative value more greatly as the sum of the signal values indicating a contact of the indicator becomes larger within the position detection range including the detected position of the indicator to calculate the magnitude of pressure applied by the indicator.

8. A display device comprising:
the touch panel system according to claim 1; and
a display unit configured to display an image,
wherein the touch panel is disposed on a display surface on which the display unit displays an image.
